(19) United States
(12) Patent Application Publication
(10) Pub. No.: US 2019/0114639 A1
(43) Pub. Date: Apr. 18, 2019

(54) ANOMALY DETECTION IN DATA TRANSACTIONS

(71) Applicant: MICROSOFT TECHNOLOGY LICENSING, LLC, Redmond, WA (US)

(72) Inventors: Eric W. Nick, Seattle, WA (US); Ming-Yu Fan, Bellevue, WA (US); Hung-Chih Yang, Redmond, WA (US); Shoou-Jiun Wang, Sammamish, WA (US); Cezary A. Marcjan, Redmond, WA (US); Jayaram NM Nanduri, Issaquah, WA (US)

(21) Appl. No.: 15/784,364

(22) Filed: Oct. 16, 2017

(51) Int. Cl. G06Q 20/40; G06F 17/30

(52) U.S. Cl. CPC G06Q 20/4016; G06F 17/30598

(57) ABSTRACT

Embodiments disclosed herein are related to computing systems and methods for detecting anomalies in a distribution of one or more attributes associated with data transactions. In the embodiments, data transactions are accessed that each include various attributes. The data transactions are grouped into a first subset associated with a first sub-type of a first attribute and a second subset including any remaining sub-types of the first attribute. Second attributes in the first and second subsets are compared to determine differences in the proportion of the second attributes between the first and second subsets, where the differences are indicative of an anomaly in an expected distribution of the second attributes. Based at least on a determination that there are differences in the proportion, subsequently accessed data transactions that are associated with attributes similar to the data transactions of the first subset are rejected or subjected to a further review process.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been, and are being, developed in all shapes and sizes with varying capabilities. As such, many individuals and families alike have begun using multiple computer systems throughout a given day.

For instance, computer systems are now used in various data transactions such as, but not limited to, in ecommerce and the like as individuals increasing perform data transactions such as making a purchase from various vendors over the Internet. In order to perform the data transactions, the individuals are typically required to provide a payment instrument such as a credit card or bank account information such as a checking account to the vendor over the Internet. The vendor then uses the payment instrument to complete the data transaction.

The process of providing the payment instrument over the Internet leaves the various merchants subject to loss from fraudulent data transactions. For example, when a fraudulent payment instrument is used to purchase a product, the merchants often loses the costs associated with the product. This is often because the bank or financial institution that issues the payment instrument holds the merchants responsible for the loss since it was the merchants who approved the transaction at the point of sale where payment instrument is not present.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments disclosed herein are related to computing systems and methods for detecting anomalies in a distribution of one or more attributes associated with data transactions. In the embodiments, data transactions are accessed that each include various attributes. The data transactions are grouped into a first subset associated with a first sub-type of a first attribute and a second subset including any remaining sub-types of the first attribute. Second attributes in the first and second subsets are compared to determine differences in the proportion of the second attributes between the first and second subsets, where the differences are indicative of an anomaly in an expected distribution of the second attributes. Based at least on a determination that there are differences in the proportion, subsequently accessed data transactions that are associated with attributes similar to the data transactions of the first subset are rejected or subjected to a further review process.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing system in which the principles described herein may be employed;

FIG. 2A illustrates a computing system that may implement the embodiments disclosed herein;

FIG. 2B illustrates an extended view of the computing system of FIG. 2A including an anomaly detection module;

FIG. 3 illustrates an embodiment of a risk score band;

FIGS. 4A and 4B illustrate examples of subsets of data transactions;

FIGS. 5A and 5B illustrate graphical examples of frequency tables;

FIG. 6 illustrates a flow chart of an example method for detecting anomalies in a distribution of one or more attributes associated with one or more data transactions;

FIG. 7 illustrates a flow chart of an example method for generating one or more frequency tables; and

FIG. 8 illustrates a flow chart of an example method for rejecting any subsequently accessed data transactions or subjecting the subsequently accessed data transactions to a further review process.

### DETAILED DESCRIPTION

Fraud is as old as humanity itself and can take various forms. Moreover, new technology development provides additional ways for criminals to commit fraud. For instance, in e-commerce the information on a card is enough to perpetrate a fraud. As EMV becomes ubiquitous, fraud at physical storefronts is evolving as well—driving a movement from counterfeit card fraud to new account fraud. Growing online retail volume have brought greater opportunity to criminals—pushing fraud to card-not-present channels.

The changes in fraudulent activities and customer behavior are the main contributors to the non-stationarity in the stream of transactions. These changes are of extreme relevance to detection models which must be constantly updated to account for the changes in behavior. If the changes in behavior are not detected in a timely manner, then a large amount of fraudulent activities may be allowed to occur.

One way that changes in fraudulent activities and customer behavior may be detected is to detect anomalies in the underlying data transactions that are used by the customers and fraudsters. Detecting anomalies in a transit environment, however, can be challenging. Many industries use human inspection as a solution. Fraud detection for e-commerce platform is one of those environments. To accurately identify a fraudulent data transaction, it usually requires a human reviewer to inspect the attributes of the transaction in details or wait for a charge-back from bank. This mainly supervised process or the supervised-learning model it helps train, are thus limited by either scope or scale of human reviewers or by the amount of time it takes to receive the charge-back.

Advantageously, the embodiments disclosed herein provide for the near real time detection of anomalies in the data transaction. In some embodiments, this is done by detecting anomalies in a distribution and proportion of various attributes that are associated with the data transactions. In circumstances where there is no (or very little) fraudulent activity occurring, then the distribution of the proportion of at least some of the associated attributes is expected to be very close across the data transactions. However, when there is fraudulent activity occurring on a large scale then the distribution of at least some of the associated attributes will be different between those data transactions where fraud is occurring and those where fraud is not occurring.

Embodiments disclosed herein are related to computing systems and methods for detecting anomalies in a distribution of one or more attributes associated with data transactions. In the embodiments, data transactions are accessed that each include various attributes. The data transactions are grouped into a first subset associated with a first sub-type of a first attribute and a second subset including any remaining sub-types of the first attribute. Second attributes in the first and second subsets are compared to determine differences in the proportion of the second attributes between the first and second subsets, where the differences are indicative of an anomaly in an expected distribution of the second attributes. Based at least on a determination there are differences in the proportion, subsequently accessed data transactions that are associated with attributes similar to the data transactions of the first subset are rejected or subjected to a further review process.

The embodiments disclosed herein provide various technical effects and benefits over the current technology. For example, one direct improvement is the embodiments disclosed herein provide for near real time detection of fraudulent activity in the data transactions. To clarify, current technologies typically require a wait of several weeks to receive information such as charge-back information from a bank or other outside evaluator to determine changes in behavior that may be related to fraudulent activity. By being able to detect anomalies in the data transactions that may be related to fraudulent activity in near real time, the disclosed embodiments allow for preventative measures to be taken much faster to stop the fraudulent activity.

The embodiments disclosed herein provide a further technical improvement by removing at least some need for further human review of the data transactions to determine fraud. As will be explained in more detail to follow, the embodiments are able to determine received data transactions that match data transactions that have already been determined to include fraudulent activity. These data transactions may then be automatically rejected, removing the need for the human review. At the very least, the number of data transactions needing the human review is reduced. Since human review is a limited resource that is very difficult to increase during a fraud attack, this is a significant improvement.

The embodiments disclosed herein provide a further technical improvement by using conditional attributes to limit the anomaly detection to relevant data transactions. This removes the processing burden from the computing systems implementing the embodiments. Further, the technical effects related to the disclosed embodiments can also include improved user convenience and efficiency gains

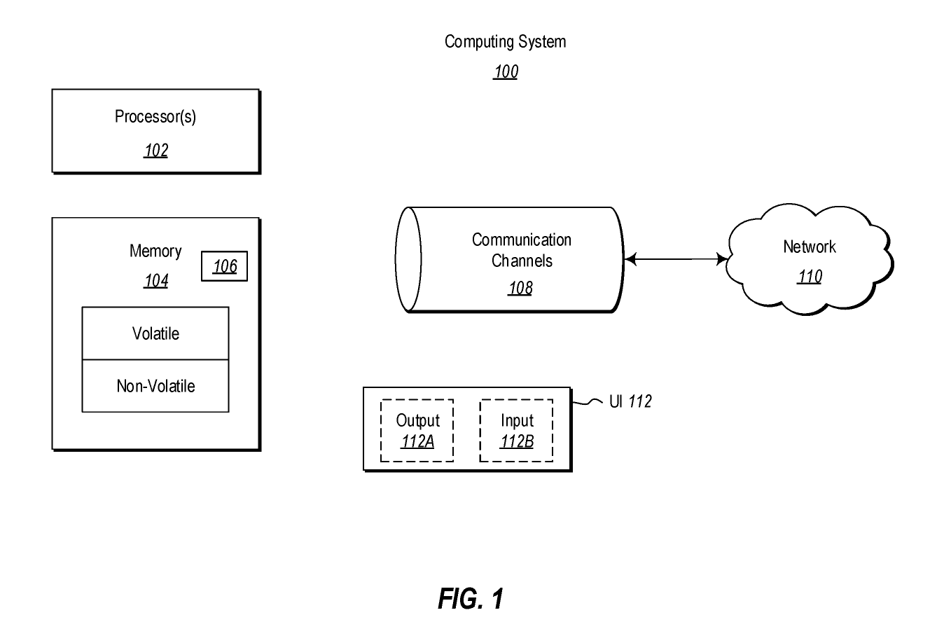

Some introductory discussion of a computing system will be described with respect to FIG. 1. Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface system 112 for use in interfacing with a user. The user interface system 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RANI and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

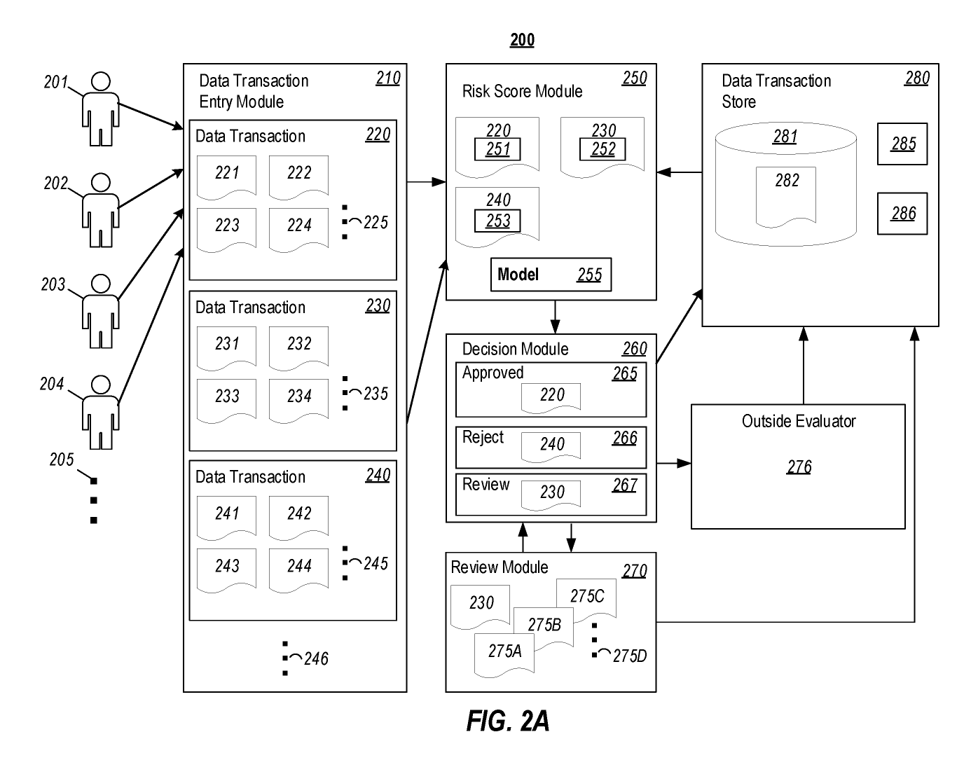

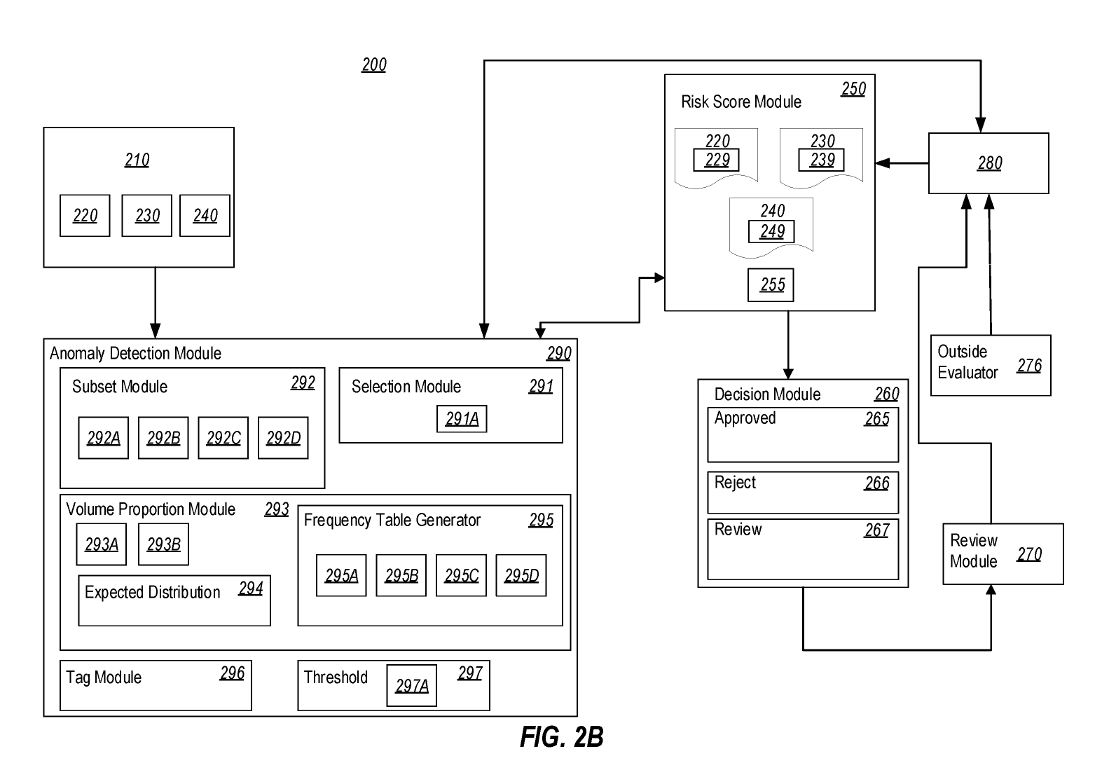

Attention is now given to FIGS. 2A and 2B, which illustrate an embodiment of a computing system 200, which may correspond to the computing system 100 previously described. The computing system 200 includes various components or functional blocks that may implement the various embodiments disclosed herein as will be explained. The various components or functional blocks of computing system 200 may be implemented on a local computing system or may be implemented on a distributed computing system that includes elements resident in the cloud or that implement aspects of cloud computing. The various components or functional blocks of the computing system 200 may be implemented as software, hardware, or a combination of software and hardware. The computing system 200 may include more or less than the components illustrated in FIGS. 2A and 2B and some of the components may be combined as circumstances warrant. Although not necessarily illustrated, the various components of the computing system 200 may access and/or utilize a processor and memory, such as processor 102 and memory 104, as needed to perform their various functions.

As shown in FIG. 2A, the computing system 200 may include a transaction entry module 210. In operation, the transaction module 210 may receive input from multiple users 201, 202, 203, 204, and any number of additional users as illustrated by the ellipses 205 to initiate a data transaction that is performed by the computing system 200. For example, the user 201 may initiate a data transaction 220, the user 202 may initiate a data transaction 230, and the user 203 may initiate a data transaction 230. The ellipses 246 represent any number of additional data transactions that can be initiated by one or more of the users 204 or 205. Of course, it will be noted that in some embodiments a single user or a number of users less than is illustrated may initiate more than one of the data transactions 220, 230, 240, or 246.

The data transactions 220, 230, 240, or 246 may represent various data transactions. For example, as will be explained in more detail to follow, the data transactions 220, 230, 240, or 246 may be purchase or other financial transactions. In another embodiments, the data transactions 220, 230, 240, or 246 may be transactions related to clinical or scientific research results. In still, other embodiments, the data transactions 220, 230, 240, or 246 may be different diseases that are being tested or treated. Accordingly, the data transactions 220, 230, 240, or 246 may be any type of transaction that is subject to an undesired result such as a fraudulent transaction and is thus able to be characterized as being properly approved, improperly approved, properly rejected, or improperly rejected as a result of the undesired result. Accordingly, the embodiments disclosed herein are not related to any particular type of data transactions. Thus, the embodiments disclosed herein relate to more than purchase or financial transactions and should not be limited or analyzed as only being related to purchase or financial transactions.

As shown, each of the data transactions may be associated with one or more attributes that provide additional information about the data transactions. For example, the data transaction 220 may be associated with an attribute 221, 222, 223, 224 and potentially any number of additional attributes as illustrated by the ellipses 225. Similarly, the data transaction 230 may be associated with an attribute 231, 232, 233, 234 and potentially any number of additional attributes as illustrated by the ellipses 235. Likewise, the data transaction 240 may be associated with an attribute 241, 242, 243, 244 and potentially any number of additional attributes as illustrated by the ellipses 245. The additional data transactions 246 may also be associated with one or more attributes.

In some embodiments, at least one of the attributes may be a first attribute that provides information that defines a data transaction type and that may have various sub-types associated with it. For example, first attribute may be, but is not limited to, an account country, a product name, a product type, a disease type, or an experiment type as this type of information defines the transaction type. As mentioned, the transaction type may have associated sub-types. For instance, if the data transaction type is a product type or product name, then the sub-types may be different product types such as computer, gaming software, or office software or the specific name of the product. Alternatively, if the data transaction type is disease type or experiment type, then the sub-types may be disease name or type or experiment name or type. Accordingly, the embodiments disclosed herein are not limited to any particular type of first attribute. In an embodiment the attributes 221, 231, and 241 may correspond to the first attribute. In some embodiments there may be more than one first attribute associated with each data transaction.

In some embodiment, one or more attributes may correspond to a second attribute that may identify or at least provide some indication as to the origin of the data transaction. These identity attributes may include, but are not limited to, a browser type or its hash, browser font size or its hash, operating system font size or its hash; browser window size or its hash, device screen resolution or its hash, email pattern, or email domain. In other words, the second or identity attributes may be any attribute that includes any information that indicates the origin of the data transactions. In many cases, these attributes are generated by a computing system or the like that is used to initiate the data transaction and then are subsequently received by the data entry module. Accordingly, the embodiments disclosed herein are not limited to any particular type of second attribute. In an embodiment the attributes 222, 223, 232, 233, 242, and 243 may correspond to the second attribute. Although only two second identity attributes are shown as being associated with each data transaction, this is for ease of illustration only and in many instances there will be many second or identity attributes associated with each data transaction.

In some embodiments, the one or more attributes may correspond to a third attribute that may be considered conditional attributes. These attributes may include, but are not limited to, geographical information, specific time information, or operating system language. These attributes are considered conditional attributes because they may be used to bound or define a distribution of the one or more second attributes as will be explained in more detail to follow. For example, if the third or conditional attributes are geographical location and operating system language and the second attribute is browser type, then the a distribution of browser type may be defined or bound by those browsers used in the geographical location, for example California, and with a specific operating system language, for example English. Accordingly, the embodiments disclosed herein are not limited to any particular type of third or conditional attribute. In an embodiment the attributes 224, 234, and 244 may correspond to the third or conditional attribute. Although only one third or conditional attribute is shown as being associated with each data transaction, this is for ease of illustration only and in many instances there may be many third or conditional attribute associated with each data transaction.

The computing system 200 may also include a risk score module 250. In operation, the risk score module 250 may determine a risk score for each of the data transactions 220, 230, and 240 based on one or more risk determination models 255. The risk scores may be a probability that is indicative of whether a given data transaction is a good transaction that should be approved or is a fraudulent or bad transaction that should be rejected. In one embodiment, the risk determination model 255 may be a gradient boosting decision tree, while in other embodiments the risk determination model 255 may be an artificial neural network or some other type of risk determination model. Accordingly, it will be appreciated that the embodiments disclosed herein are not limited by a particular type of risk determination model 255.

As mentioned, the risk score module 250 may determine a risk score for each of the data transactions based on one or more risk determination models 255. For example, the risk score module may determine a risk score 251 for the data transaction 220, a risk score 252 for the data transaction 230, and a term risk score 253 for the data transaction 240. The risk score module 250 may also determine a risk score for each of the additional data transactions 246. As will be explained in more detail to follow, the risk scores 251-253 may specify if each of the data transactions is to be approved (i.e., the data transactions are performed or completed), if the transactions are to be rejected (i.e., the data transactions are not completed or performed) or if further review is needed to determine if the data transaction should be approved or rejected.

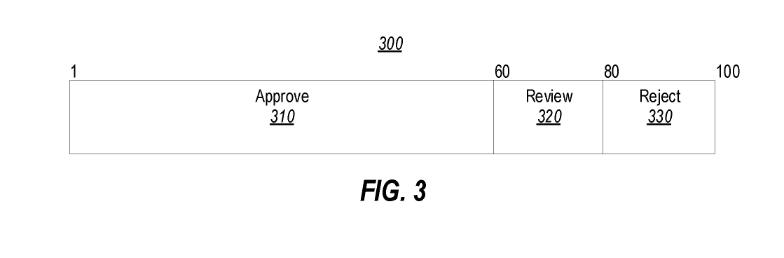

The computing system 200 may further include a decision module 260 that in operation uses the risk scores 251-253 to determine if a data transaction should be approved, rejected or subjected to further review based on the term risk score. That is, the decision module 260 may set or otherwise determine a risk score cutoff or boundary for risk scores that will be approved, risk scores that will rejected, and risk scores that will be subjected to further review. For example, FIG. 3 shows risk scores from 1 to 100. As illustrated, those data transactions (i.e., data transactions 220, 230, 240) that are assigned a risk score (i.e., risk scores 251-253) between 1 and 60 are included in an approve portion 310 and those data transactions that are assigned a risk score from 80 to 100 are included in a rejected portion 330. However, those data transactions having a risk score between 60 and 80 are included in a review portion 320 that are to be subjected to further review. Thus, in the embodiment the risk score 60 is a first cutoff or boundary and the risk score 80 is a second cutoff or boundary. It will be noted the FIG. 3 is only one example of possible risk scores and should not be used to limit the embodiments disclosed herein.

As illustrated in FIG. 2A, it is shown at 265 that the data transaction 220 has been approved because the risk scores 251 was in the risk score band that should be approved. For instance, in relation to the embodiment of FIG. 3 the risk score 251 may be between 1 and 60. Accordingly, the data transaction 220 is able to be completed by the computing system 200. The data transaction 240, on the other hand, is shown at 266 as being rejected because the risk score 253 was in the risk score band that should be rejected. For instance, in relation to the embodiment of FIG. 3 the risk score 253 was between 80 and 100. Accordingly, the data transaction 240 is not completed by the computing system 200.

As further shown in FIG. 2A at 267, the data transaction 230 has been marked for further review because the risk score 252 was in the risk score band that should be subjected to further review. For instance, in relation to the embodiment of FIG. 3 the risk score 252 was between 60 and 80. Accordingly, the computing system 200 may also include a review module 270, which may be a computing entity or a human entity that utilizes the review module 270. In operation, the review module 270 receives the data transaction 230 and performs further review on the data transaction to determine if the data transaction should be approved or rejected. For example, the review module may apply one or more additional review criteria 275a, 275b, 275c, and any number of additional review criteria as illustrated by ellipses 275d (hereinafter also referred to “additional review criteria 275”). In some embodiments the additional review criteria 275 may be to review of social media accounts of the initiator of the data transaction, review and/or contact of third parties associated with the initiator of the data transaction, contact with a credit card company that issues a credit card associated with the initiator of the data transaction, or direct contact with the initiator of the data transaction through a phone call, SMS, email, or other real time (or near real time) forms of communication. It will be appreciated that there may be other types of additional review criteria.

Based on the results of the additional review criteria 275, the review module 270 may determine if the data transaction 230 should be approved or rejected. For example, if the additional review criteria indicate that it is likely that the data transition 230 is a valid, non-fraudulent transaction, then the data transaction 230 may be approved. On the other hand, if the additional review criteria indicate that it is likely that the data transition 230 is a fraudulent transaction, the data transaction may be rejected. The determination of the review module 270 may be provided to the decision module 260 and the data transaction 230 may be added to the approved data transactions 265 and allowed to be completed or added to the rejected data transactions 266 and not allowed to be completed.

The computing system 200 may include a data transaction store 280 that includes a database 281 that stores previously received data transactions 220, 230, 240, and 246 and information 282 related to data transactions 220, 230, 240, and 246 that have been completed or rejected based on the term risk scores 251-253 that were assigned to the data transactions by the risk score module 250 using the risk model 255.

As shown in FIG. 2A, the data transaction store 280 may receive the data 282 regarding whether the data transactions were approved or rejected from the decision module 260. As may be appreciated, the determination module is able to report which of the data transactions were approved, which were sent for further review and which were rejected. The review module 270 may also provide data 282 that specifies which of the data transactions that were subjected to the further review were ultimately approved or rejected. The data transaction store 280 may receive the data 282 from other sources as well when circumstances warrant.

In some embodiments, the data transaction store 280 may receive data 282 from an outside evaluator 276. The outside evaluator may be a bank or the like that determines that a data transaction approved by the decision module should have been rejected because the payment source used in the data transaction was fraudulently used or obtained. In such case, the outside evaluator may notify the data transaction store 280 that the data transaction should have been rejected, for example by providing charge-backs to the owner of the computing system 200.

The data transaction store 280 may include a training module 285 that is able to use the data 282 to determine if the model 255 is providing a proper risk score. This information may then be used to train the model 255 so as to further refine the model's ability to properly determine a risk score. The training module 285 may train the model 255 in any reasonable manner.

As may be appreciated, those data transactions, such as data transaction 220 which was approved by the decision module 260 based on the risk score may be performed by the computing system 200. Thus, in the embodiment where the data transactions are a purchase or other financial transaction the computing system may perform the purchase by receiving payment from the user and then providing the product to the user. In such case, the training module 285 is able to determine if a data transaction was properly approved, which is if the user actually paid for the product. The training module 285 is also able to determine if a data transaction was improperly approved, that is if the user provided a fraudulent payment instrument and received a chargeback from the outside evaluator 276.

However, the data transactions such as data transaction 240 that are rejected by decision module 260 based on the risk score are not actually performed or completed by the computing system 200. Accordingly, to determine if these transactions were properly rejected or not, the term training module may include or otherwise have access to a sampling module 286. In operation, the sampling module 286 randomly approves a subset of the data transactions that are scored to be rejected so that the data transactions are approved. The sampling module 286 may then sample this subset to determine the outcome of the data transaction.

For example, in the embodiment where the data transactions are a purchase or other financial transaction, the sampling module 286 may determine how many data transactions in the subset were properly completed, that is the user paid for the product. Since these were successful data transactions, they were improperly rejected. Likewise, the sampling module 286 may determine how many data transactions in the subset were not properly completed, that is the user paid for the product by a fraudulent means and were thus properly rejected. The sampling module 286 may then use statistical analysis based on the subset to determine if the remaining data transactions that were rejected based on the term risk score were properly rejected or not.

Although the risk score module 250 and its accompanying risk determination model 255 are generally able to properly detect an unwanted result such as fraud in the data transactions and thus assign a risk score that properly rejects a fraudulent data transaction, changes often occur in user 201-205 behavior and also in any fraudulent activity that might be attempted by one or more of the users 201-205. These changes may take a time before they are accounted for by the risk determination model 255 since there is generally a time delay, often several weeks or months, in receiving any information 282 from the outside evaluator 270. Accordingly, an increased number of fraudulent data transactions may be approved before the risk determination model 255 is able to account for the changes in behavior and detect the fraud. In addition, any changes in the user 201-205 behavior and also in any fraudulent activity that might be attempted by one or more of the users 201-205 may result in an increase in the number of data transactions that are flagged for further review by the review module 270. As may be appreciated, however, the review module 270 may have limited resources to perform the further review and thus may not be able to effectively handle the increases in further review requests, thus decreasing the efficiency of the computing system 200.

Advantageously, the embodiments disclosed herein include an anomaly detection module 290 that in operation is configured to detect anomalies in the data transactions such as a distribution of one or more of the second attributes (i.e., second attributes 222, 232, and 242) for a given first attribute when compared to other data transactions having a similar first attribute. Any detected anomalies may infer that an unwanted result such as a fraud attack is currently occurring in at least some of the data transactions 220, 230, 240, and 246. This process will be explained in more detail to follow.

FIG. 2B illustrates an extended view of the computing system 200. Accordingly, those elements of computing system 200 already discussed in relation to FIG. 2A may not be included in FIG. 2B. As shown in FIG. 2B, the computing system 200 may include the anomaly detection module 290. The anomaly detection module 290 may include a selection module 291. In operation, the selection module may allow a user of the computing system 200 or some other entity to select the first, second, and third attributes that may be used by the anomaly detection module 290 in its operation. For example, in one embodiment the user may select a first attribute to be product type, with a corresponding sub-type being computer. In the embodiment, a second attribute may be selected to be one or more of browser type or its hash, browser font size or its hash, operating system font size or its hash; browser window size or its hash, device screen resolution or its hash, email pattern, or email domain. In the embodiment, a third attribute may also be selected to bound or define the distribution of the one or more second attributes. In the embodiment, the third attribute may be one of geographical location, specific time, or language, such as California, 8 Am-9 Am and English. The selection of the first, second and third attributes is represented at 291a in the figure.

The anomaly detection module 290 may also include a subset module 292. In operation, the subset module 292 may access the data transactions 220, 230, 240, and 246, either directly from the data transaction entry module 210 or from the data transaction store 280. Once the data transactions have been accessed, the subset module 292 may group the data transactions into a first subset 292a and a second subset 292b based on the first attribute (i.e., 221, 231, 241) associated with each of the data transactions. For example, suppose that the selected first attribute was product type, with a sub-type being product A, which may be a computer. The subset module 292 may generate the first subset 292a to include those data transactions having a first attribute that define the data transaction as a data transaction for the purchase of a product A, such as a computer. The subset module 2912 may also generate the second subset 292b to include those data transactions having a first attribute that define the data transaction as a data transaction for the purchase of a product type other than product A, such as products B, C, and D.

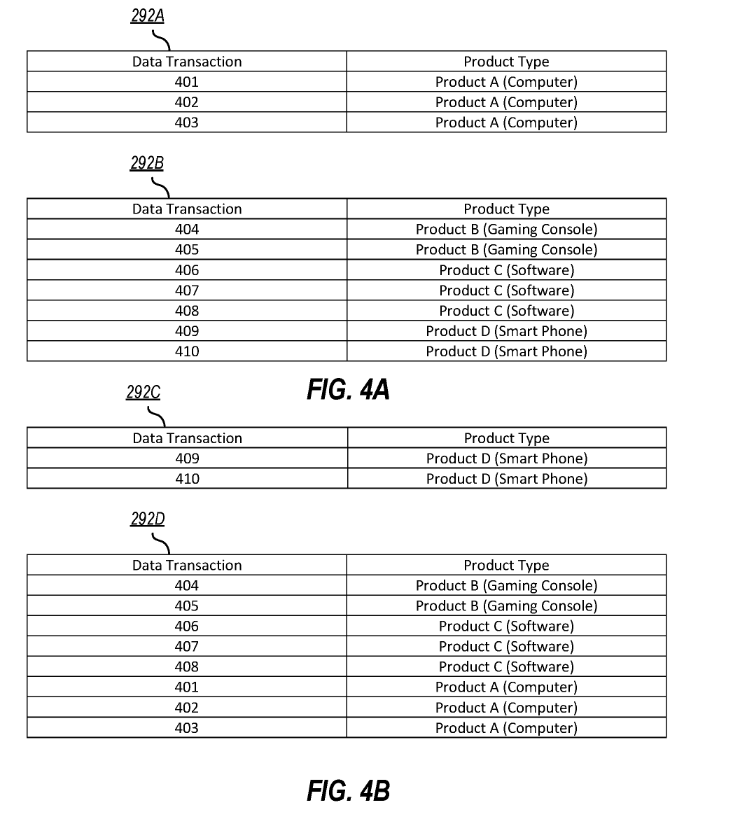

FIG. 4A illustrates an example of the first subset 292A and the second subset 292B. As illustrated, the first subset 292A includes three data transactions 401-403 that may correspond to the data transactions 220, 230, 240, and 246. As further illustrated, each of these data transactions is associated with a first attribute that indicates the data transactions is for the purchase of product A, which in the embodiment is a computer.

The second subset 292B includes data transactions 404-410, which may also correspond to the data transactions 220, 230, 240, and 246. As further illustrated, the data transactions 404-405 are associated with a first attribute that indicates the data transactions are for the purchase of product B, which in the embodiment is a gaming console. The data transactions 406-408 are associated with a first attribute that indicates the data transactions are for the purchase of product C, which in the embodiment is a software. The data transactions 409-410 are associated with a first attribute that indicates the data transactions are for the purchase of product D, which in the embodiment is a smart phone.

The anomaly detection module 290 may further include a proportion comparison module 293. In operation, the proportion comparison module 293 receives or otherwise accesses the first subset 292a and the second subset 292b. The proportion comparison 293 may then determine a proportion 293a of the one or more second attributes (i.e., 222, 223, 232, 233, 242, and 243) that are associated with the data transactions found in the first subset 292a and a proportion 293b with the one or more second attributes that are associated with the data transactions found in the second subset 292b. As mentioned above, in some embodiments the determination of the proportion of the one or more second attributes will be bounded by or a distribution will be defined by the one or more third or conditional attributes (i.e., 224, 234, and 244).

For example, in the embodiment where the first and second subsets are generated based on product type as previously explained, each subset may include several different second attributes such as those previously mentioned. In such embodiment, the one or more third attributes may be California and English. Accordingly, only those second attributes that were generated in California and that use English are included in the proportions 293a and 293b. As may be appreciated, there may be differences between the one or more second attributes between different geographical locations, during different time periods, or with the use of different languages since behavior of the users 201-205 may be different in the different locations, time periods, or those who use a different language. Accordingly, bounding or defining the distribution of the one or more second attributes by the one or more third or conditional attributes allows for the determinations of any anomalies between the proportions 293a and 293b to more indicative of an unwanted result such as a fraud attack and not to reflect anomalies caused by differences in the behavior of the users 201-205 caused by the differences in location, time, or language.

The proportion comparison module 293 may then compare the proportion 293a and 293b to determine if there are any differences in the proportions. In the case where there are no (or at least an insignificant amount) of differences, then it may be inferred by the anomaly detection module that it is likely there are no anomalies that would be indicative of an unwanted result such as a fraud attack. In other words, if there is no current unwanted result occurring in the data transactions then the distribution of the one or more second attributes in both the first and second subsets would typically be close to each other and would be close to an expected distribution 294 of the one or more second attributes. For example, if the second attribute were browser type, then with no fraud attack occurring the distribution of a given browser type should be close to each other for all data transactions having the same first attribute type since the various users 201-205 would be expected to use a given browser type, such as Chrome, Internet Explorer, Firefox, or Edge, equally to make purchases of products A, B, C, and D. The distribution in both subsets would likely match the expected distribution 294.

However, in cases where there are significant differences in the proportions 293a and 293b, then it may be inferred by the anomaly detection module that it is likely there are anomalies that would be indicative of an unwanted result such as a fraud attack occurring in the data transactions of the first subset 292a. That is, if the distribution of the one or more second attributes in the second subset 292b is still close to the expected distribution 294, but the distribution of the one or more second attributes in the first subset 292a is different from the expected distribution 294, then it is likely that an unwanted result such as a fraud attack is occurring. For example, if the second attribute is browser type, then an increase in the proportion of a given browser type, for example Edge, is indicative of a fraud attack because fraudsters will often use a single browser to create multiple fake accounts with which they will then use to initiate multiple data transactions 220, 230, 240, and 246. This is why the increase in the proportion of the given browser type occurs. The proportion comparison module 293 may then determine new proportions 293a and 293b for each of the additional second attributes as needed and may then determine any differences in the distribution of these modules as needed.

In some embodiments, the proportion comparison module 293 includes a frequency table generation module or generator 295. In operation, the frequency table generator 295 may generate a frequency table 295a for the first subset 292a and a second frequency table 295b for the second subset 292b. The frequency tables may be used to determine the proportions 293a and 293b of the one or more second attributes in each of the first and second subsets.

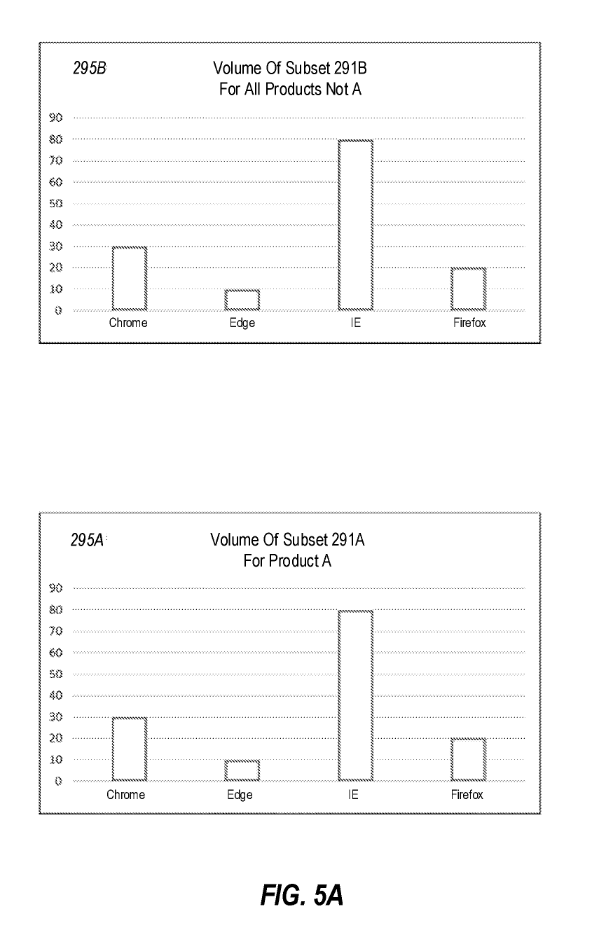

FIG. 5A illustrates a graphical example of the frequency tables 295a and 295b for the embodiment when the first subset 292a includes the data transaction associated with product A and the second subset includes the data transactions associated with products B, C, and D and where the second attribute is browser type. As shown in FIG. 5A, there are four browser types, Chrome, Edge, Internet Explorer (IE), and Firefox. A comparison of the frequency tables shows that the proportion of each browser type is substantially the same. In other words, the distribution of each browser type is substantially the same for product A and for the remaining products. Accordingly, when comparing these frequency tables, the proportion comparison module 293 may infer that it is likely that there is no unwanted result such as a fraud attack occurring in the data transactions of the first subset 292a.

FIG. 5B also illustrates a graphical example of the frequency tables 295a and 295b for the embodiment when the first subset 292a includes the data transaction associated with product type A and the second subset includes the data transactions associated with product types B, C, and D and where the second attribute is browser type. As shown in FIG. 5B, there are the four browser types, Chrome, Edge, Internet Explorer (IE), and Firefox. In contrast to FIG. 5A, a comparison of the two frequency tables shows a large difference in the proportion of the browser type Edge between the frequency tables. In other words, the distribution of browser type Edge is much larger for product type A then it is for the product types B, C, and D. Accordingly, when comparing these frequency tables, the proportion comparison module 293 may infer that it is likely that there is an unwanted result such as a fraud attack occurring in the data transactions of the first subset 292a. As mentioned above, it is possible that fraudsters are using the Edge browser to create multiple fake accounts in an attempt to fraudulently purchase the product type A, which in the embodiment is a computer.

After generating the frequency tables for the second attribute browser type, the frequency table generator 295, may generate new frequency tables 295c and 295d for the remaining second attributes associated with the first and second subsets. In many instances there will be a large number of frequency tables 295c and 295d generated. The proportion comparison module 293 may then determine any differences in proportions of the second attributes that are the basis of the various frequency tables 295c and 295d by comparing the frequency tables in the manner described for frequency tables 295a and 295b and may determine if there are any anomalies.

The anomaly detection module 290 may repeat the process just described for the data transactions associated with the first attribute product type A for the remaining first attributes of the data transactions. For example, as illustrated in FIG. 4B, the subset module 292 may generate a third subset 292c for those data transactions associated with a first attribute for product type D (smart phone), which in the illustrated embodiment are data transactions 409 and 410. Likewise, a fourth subset 292d is generated for those data transactions having a first attribute for product types A, B, and C, which is data transactions 401-408. The proportion comparison module 293 may then determine any differences between the proportions of the one or more second attributes for the third and fourth subsets as bounded by the one or more third attributes in the manner previously described.

The anomaly detection module 290 may also include a tagging module 296. In operation, the tagging module 296 may receive from the proportion comparison module the instances where an anomaly based on the difference in the proportion of the one or more second attributes has been found and which may indicate a fraudulent attack. The tagging module 296 may then keep a record of any such anomalies.

The anomaly detection module 290 may also include a threshold module 297. As may be appreciated, there may be instances where anomalies in the distribution of the one or more second attributes may occur for reasons other than an unwanted result such as a fraudulent attack. Alternatively, even in cases where a fraudulent attack may be occurring, the number of detected anomalies may be too small to warrant any additional procedures by the computing system 200. Accordingly, the threshold module may include a predetermined threshold 297A that specifies a level of anomalies in the distribution of the one or more second attributes that should be found before any action is taken by the tagging module 296.

When data transactions 220, 230, 240, and 246 are subsequently received by the anomaly detection module 290, the module is able to determine if any of the subsequently received data transactions include substantially similar attributes to those of the first subset 292a (or third subset 292c or any other subset that has been tested for anomalies in the distribution of the second attributes) for which a number of anomalies exceeding the threshold 297a have been determined or for which any anomalies have been determined for those embodiments without the threshold. If a subsequently received data transaction includes substantially similar attributes, then the tagging module 296 may tag those data transactions before they are sent to the risk score module 250. For example, FIG. 2B shows a subsequently received data transaction 220 has been tagged with a tag 229, a subsequently received data transaction 230 has been tagged with a tag 239, and a subsequently received data transaction 240 has been tagged with a tag 249.

The risk score module 250 and decision module 260 may use the tags 229, 239, and 249 when determining to approve, reject, or subject the data transactions to the further review process. For example, if there are a large number of data transactions that have been tagged during a short time frame, this may indicate a currently occurring fraud attack. Accordingly, the risk score module 250 and decision module 260 may outright reject such data transactions until such time as the tagging subsides. Alternatively, the risk score module 250 and decision module 260 may adjust the risk score cutoff so that more of the tagged data transactions are rejected or are subjected to the further review process and less of the data transactions are automatically approved. The risk score module 250 and decision module 260 may also implement other ways to ensure that the data transactions that likely have an occurring fraud attack are not automatically approved.

Advantageously, the tagging module 296 is able to tag the subsequently received data transactions in near real time, thus avoiding the long wait that traditional methods required before detecting fraud. By constantly performing the above described process on accessed or received data transactions during a short sliding window, for example a one hour window, the anomaly detection module 290 is able to in near real time detect fraud attacks and to generate the tags that can be used in the manner previously described to combat the fraud attack.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

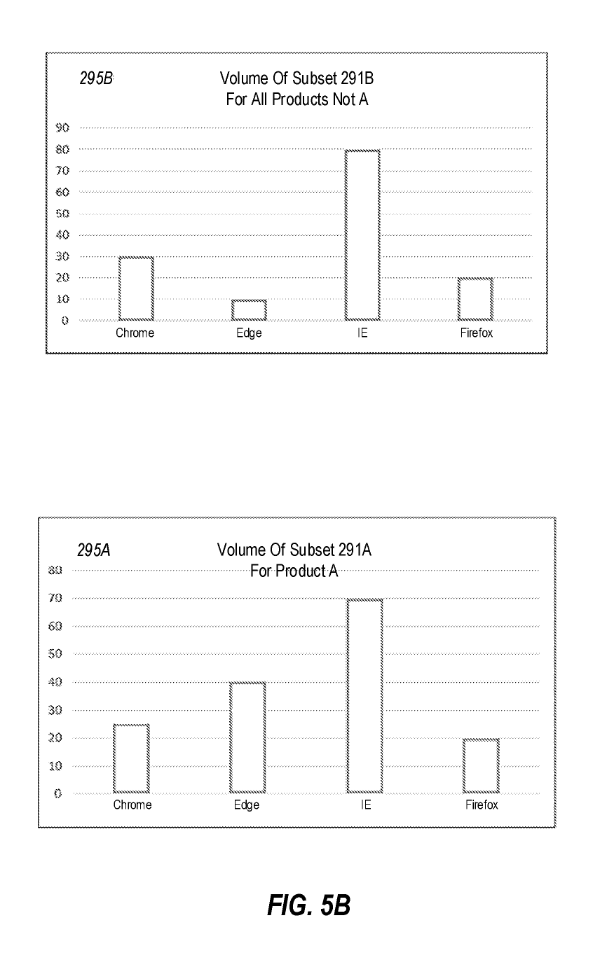

FIG. 6 illustrates a flow chart of an example method 600 for detecting anomalies in a distribution of one or more attributes associated with one or more data transactions. The method 600 will be described with respect to one or more of FIGS. 2-4 discussed previously.

The method 600 includes accessing one or more data transactions, each data transaction associated with a plurality of attributes that provide information associated with the data transaction, the plurality of attributes including at least a first attribute that defines a data transaction type having a plurality of sub-types and one or more second attributes that identify an origin of the transaction (610). For example, as previously described the anomaly detection module may access or otherwise receive one or more of the data transactions 220, 230, 240, and 246. Each of the data transactions may be associated with a first attribute such as attribute 221, 231, and 241 that that provides information that defines a data transaction type and that may have various sub-types associated with it. For example, first attribute may be, but is not limited to, an account country, a product name, a product type, a disease type, or an experiment type as this type of information defines the transaction type. As mentioned, the transaction type may have associated sub-types. For instance, if the data transaction type is a product type or product name, then the sub-types may be different product types such as computer, gaming software, or office software or the specific name of the product. Alternatively, if the data transaction type is disease type or experiment type, then the sub-types may be disease name or experiment name.

Each of the data transactions may also be associated with a second attribute such as attribute 222, 223, 231, 232, 242, and 243 that that provide information that that identifies an origin of the data transaction. For example, the identity attributes may include, but are not limited to, a browser type or its hash, browser font size or its hash, operating system font size or its hash; browser window size or its hash, device screen resolution or its hash, email pattern, or email domain. Thus, the second attributes may be any attribute that includes any information that indicates the origin of the data transactions. In many cases, these attributes are generated by a computing system or the like that is used to initiate the data transaction.

Each of the data transactions may also be associated with one or more third or conditional attributes such as attributes 224, 234, 244. These attributes may include, but are not limited to, geographical information, specific time information, or operating system language. These attributes are considered conditional attributes because they be used to bound or define a distribution of the one or more second attributes.

The method 600 includes grouping the plurality of data transactions into a first subset of data transactions that are associated with a first sub-type of the first attribute and a second subset of data transactions that includes any remaining sub-types of the first attribute (620). For example as previously described the subset module 292 may group those data transactions associated with a first sub-type of the first attribute, such as product type A (computer), may be grouped into the first subset 292a. Those data transactions that are associated with the remaining sub-types of the first attribute, such as products types B (gaming console), C (software), and D (smart phone) may be grouped into the second subset 292b. Examples of the first and second subsets 292a and 292b may are illustrated in FIG. 4A.

The method 600 includes comparing the one or more second attributes in the first subset of data transactions with the one or more second attributes in the second subset of data transactions to determine if there are one or more differences in a proportion of the one or more second attributes between the first and second subsets of data transactions, the one or more determined differences being indicative of an anomaly in an expected distribution of the one or more second attributes (630). For example, as previously described the proportion comparison module 293 determines a proportion 293a for the one or more second attributes of the first subset 292a and a proportion 293b for the one or more second attributes of the second subset 292b. The proportion comparison module 293 may then determine if there is a difference in the proportions, the difference being indicative of an anomaly in an expected distribution 294. In some embodiments, the determination of the differences in the proportion may be performed according to a method 700 that will be described in more detail to follow.

The method 600 includes, based at least on a determination there is one or more differences in the proportion of the one or more second attributes between the first and second subsets of data transactions, rejecting any subsequently accessed data transactions that are associated with a plurality of attributes substantially similar to the plurality of attributes associated with the data transactions of the first subset or subject the subsequently accessed data transactions to a further review process (640). For example, as previously described the anomaly detection module 290 may determine when any subsequently accessed or received data transactions 220, 230, 240, or 246 have attributes that substantially similar to the data transactions in the first subset 291a. In some embodiments, this may be performed according to a method 800 that will be described in more detail to follow. This information may then be provided to the risk score module 250 and the decision module 260. The risk score module 250 and the decision module 260 may reject the subsequently received data transactions or subject some of them to further review in the manner previously described.

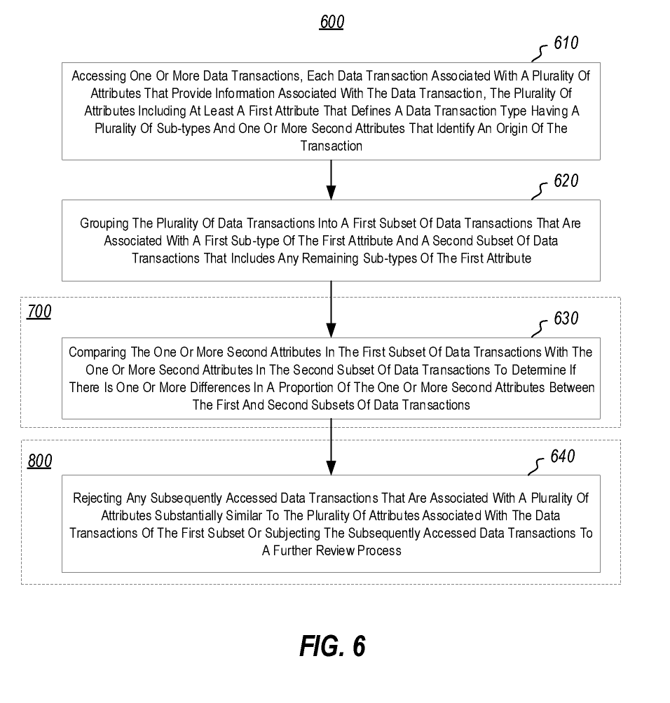

FIG. 7 illustrates a method 700 for generating one or more frequency tables to help determine a difference in a proportion of the one or more second attributes in the first subset and the second subset. The method 700 includes generating a first frequency table for the one or more second attributes in the first subset (710). For example as previously described the frequency table generator 295 generates a first frequency table 295a that includes the proportion of the one or more second attributes for the first subset 292a.

The method 700 includes generating a second frequency table for the one or more second attributes in the second subset (720). A second frequency table 295b that includes the proportion of the one or more second attributes for the second subset 292b may also be generated by the frequency table generator 295. The frequency tables 295a and 295b may be used in the determination of any differences in the proportions of the one or more second attributes between the first and second subsets. Examples of the frequency tables are shown in FIGS. 5A and 5B.

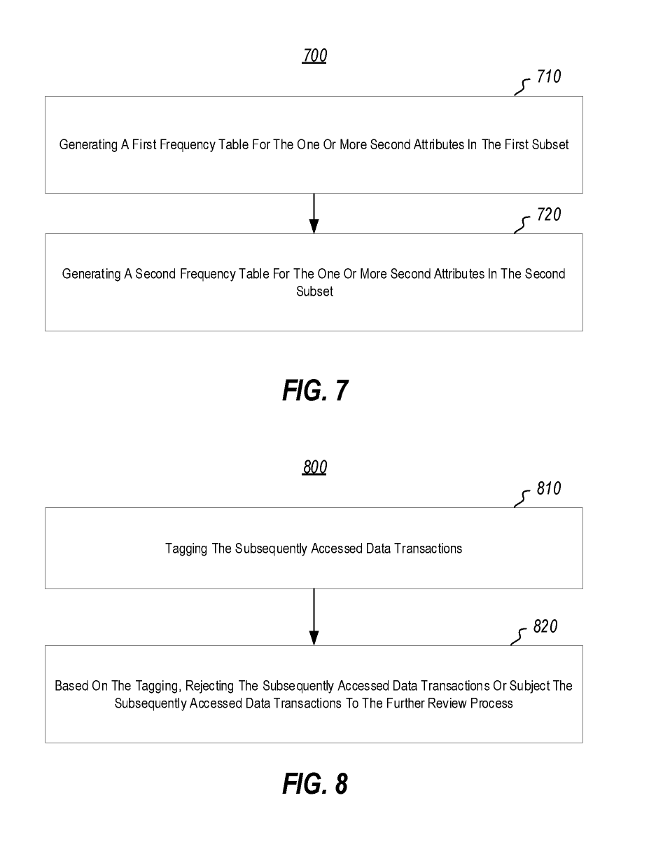

FIG. 8 illustrates a method 800 for rejecting any subsequently accessed data transactions or subjecting the subsequently accessed data transactions to a further review process. The method 800 includes tagging the subsequently accessed data transactions (810). For example as previously described the tag module 296 may tag the subsequently received or accessed data transactions 220, 230, 240 that have substantially similar attributes with a tag 229, 239, and 249 in the manner previously described.

The method 800 includes based on the tagging, rejecting the subsequently accessed data transactions or subject the subsequently accessed data transactions to the further review process (820). For example, the risk score module 250 and the decision module 260 may reject the subsequently received data transactions or subject some of them to further review based on the tagging in the manner previously described.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system configured to detect anomalies in a distribution of one or more attributes associated with one or more data transactions, the computing system comprising:
at least one processor;
a computer readable hardware storage device having stored thereon computer-executable instructions which, when executed by the at least one processor, configure the at least one processor to:
access one or more data transactions, each data transaction associated with a plurality of attributes that provide information associated with the data transaction, the plurality of attributes including at least a first attribute that defines a data transaction type having a plurality of sub-types and one or more second attributes that identify an origin of the transaction;
group the plurality of data transactions into a first subset of data transactions that are associated with a first sub-type of the first attribute and a second subset of data transactions that includes any remaining sub-types of the first attribute;
compare the one or more second attributes in the first subset of data transactions with the one or more second attributes in the second subset of data transactions to determine if there are one or more differences in a proportion of the one or more second attributes between the first and second subsets of data transactions, the one or more determined differences being indicative of an anomaly in an expected distribution of the one or more second attributes; and
based at least on a determination that there are one or more differences in the proportion of the one or more second attributes between the first and second subsets of data transactions, reject any subsequently accessed data transactions that are associated with a plurality of attributes substantially similar to the plurality of attributes associated with the data transactions of the first subset or subject the subsequently accessed data transactions to a further review process.

2. The computing system of claim 1, wherein rejecting any subsequently accessed data transactions or subjecting the subsequently accessed data transactions to a further review process comprises:
tag the subsequently accessed data transactions; and
based on the tagging, reject the subsequently accessed data transactions or subject the subsequently accessed data transactions to the further review process.

3. The computing system of claim 1, further comprising a predetermined threshold, wherein the subsequently accessed data transactions are rejected or subjected to the further review process when the determined differences in the proportion of the one or more second attributes in first subset exceed the threshold.

4. The computing system of claim 1, wherein the anomaly in the expected distribution of the one or more second attributes is indicative of an undesired result currently occurring in the data transactions of the first subset.

5. The computing system of claim 1, wherein the computer-executable instructions, when executed by the at least one processor, further configure the at least one processor to:
group the plurality of data transactions into a third subset of data transactions that are associated with a second sub-type of the first attribute and a fourth subset of data transactions that includes any remaining sub-types of the first attribute;
compare the one or more second attributes in the third subset of data transactions with the one or more second attributes in the fourth subset of data transactions;
based on the comparison, determine if there is one or more differences in a proportion of the one or more second attributes between the third and fourth subsets of data transactions, the one or more determined differences being indicative of the anomaly in the expected distribution of the one or more second attributes; and
based at least on a determination that there are one or more differences in the proportion of the one or more second attributes between the third and fourth subsets of data transactions, reject any subsequently accessed data transactions that are associated with a plurality of attributes substantially similar to the plurality of attributes associated with the data transactions of the third subset or subject the subsequently accessed data transactions to a further review process.

6. The computing system of claim 1, wherein the first attribute is one of an account country, a product name, a product type, a disease, or experiment type.

7. The computing system of claim 1, wherein the one or more second attributes are one or more of a browser type or its hash, browser font size or its hash, operating system font size or its hash; browser window size or its hash, device screen resolution or its hash, email pattern, or email domain.

8. The computing system of claim 1, wherein the one or more the plurality of attributes for each data transaction further includes one or more conditional attributes, the one or more conditional attributes defining the expected distribution of the one or more second attributes.

9. The computing system of claim 1, wherein determining if there are one or more differences in a proportion of the one or more second attributes between the first and second subsets comprises generating one or more frequency tables that show the proportion of the one or more second attributes.

10. A method for detecting anomalies in a distribution of one or more attributes associated with one or more data transactions, the method comprising:
accessing, at a processor of a computing system, one or more data transactions, each data transaction associated with a plurality of attributes that provide information associated with the data transaction, the plurality of attributes including at least a first attribute that defines a data transaction type having a plurality of sub-types and one or more second attributes that identify an origin of the transaction;
grouping the plurality of data transactions into a first subset of data transactions that are associated with a first sub-type of the first attribute and a second subset of data transactions that includes any remaining sub-types of the first attribute;
comparing the one or more second attributes in the first subset of data transactions with the one or more second attributes in the second subset of data transactions to determine if there is one or more differences in a proportion of the one or more second attributes between the first and second subsets of data transactions, the one or more determined differences being indicative of an anomaly in an expected distribution of the one or more second attributes;
tagging, based at least on a determination that there are one or more differences in the proportion of the one or more second attributes between the first and second subsets of data transactions, any subsequently accessed data transactions being associated with a plurality of attributes substantially similar to the plurality of attributes associated with the data transactions of the first subset; and
based on the tagging, rejecting the subsequently accessed data transactions or subjecting the subsequently accessed data transactions to a further review process.

11. The method of claim 10, wherein the subsequently accessed data transactions are rejected or subjected to the further review process when the determined differences in the proportion of the one or more second attributes in first subset exceeds a predetermined threshold.

12. The method of claim 10, wherein the anomaly in the expected distribution of the one or more second attributes is indicative of an undesired result currently occurring in the data transactions of the first subset.

13. The method of claim 10, further comprising:
grouping the plurality of data transactions into a third subset of data transactions that are associated with a second sub-type of the first attribute and a fourth subset of data transactions that includes any remaining sub-types of the first attribute;
comparing the one or more second attributes in the third subset of data transactions with the one or more second attributes in the fourth subset of data transactions;
based on the comparison, determining if there is one or more differences in a proportion of the one or more second attributes between the third and fourth subsets of data transactions, the one or more determined differences being indicative of the anomaly in the expected distribution of the one or more second attributes; and
based at least on a determination that there are one or more differences in the proportion of the one or more second attributes between the third and fourth subsets of data transactions, rejecting any subsequently accessed data transactions that are associated with a plurality of attributes substantially similar to the plurality of attributes associated with the data transactions of the third subset or subject the subsequently accessed data transactions to a further review process.

14. The method of claim 10, wherein the first attribute is one of an account country, a product name, a product type, a disease, or experiment type.

15. The method of claim 10, wherein the one or more second attributes are one or more of a browser type or its hash, browser font size or its hash, operating system font size or its hash; browser window size or its hash, device screen resolution or its hash, email pattern, or email domain.

16. The method of claim 10, wherein the one or more the plurality of attributes for each data transaction further includes one or more conditional attributes, the one or more conditional attributes defining the expected distribution of the one or more second attributes.

17. The method of claim 16, wherein the one or more conditional attributes includes one or more of geographic location, specific time, or specific language.

18. A computing system configured to detect anomalies associated with one or more data transactions, the computing system comprising:
at least one processor;
a computer readable hardware storage device having stored thereon computer-executable instructions which, when executed by the at least one processor, configure the at least one processor to:
access one or more data transactions, each data transaction associated with a plurality of attributes that provide information associated with the data transaction, the plurality of attributes including at least a first attribute that defines a data transaction type having a plurality of sub-types and one or more second attributes that identify an origin of the transaction, and one or more third attributes that define a distribution of the one or more second attributes;
generate a first subset of the plurality of data transactions that are associated with a first sub-type of the first attribute and a second subset of the plurality of data transactions including any remaining sub-types of the first attribute;
generate one or more frequency tables for the one or more second attributes included in the first and second subsets, the frequency tables being bounded by the one or more third attributes;
determine, based on the one or more frequency tables, if a distribution of a proportion of the one or more second attributes in the first subset is greater than the distribution of the proportion of the one or more second attributes in the second subset, wherein a difference in the proportion between the subsets is indicative of an anomaly in an expected distribution of the one or more second attributes;
tag, based at least on a determination that the distribution of the proportion of the one or more second attributes in the first subset is greater, any subsequently accessed data transactions being associated with a plurality of attributes substantially similar to the plurality of attributes associated with the data transactions of the first subset; and
based on the tagging, reject the subsequently accessed data transactions or subjecting the subsequently accessed data transactions to a further review process.

19. The computing system of claim 18, wherein the first attribute is one of an account country, a product name, a product type, a disease, or experiment type.

20. The computing system of claim 18, wherein the one or more second attributes are one or more of a browser type or its hash, browser font size or its hash, operating system font size or its hash; browser window size or its hash, device screen resolution or its hash, email pattern, or email domain.
